(19) United States
(12) Patent Application Publication
(10) Pub. No.: US 2013/0065718 A1
(43) Pub. Date: Mar. 14, 2013

(54) Counter-Rotation Electric Machine

(71) Applicants: Alfredo R. Munoz, Ann Arbor, MI (US); Michael W. Degner, Novi, MI (US); Michael T. Berhan, Sylvania, OH (US); Shaun G. Knowles, Canton, MI (US); Thomas A. McGinn, White Lake, MI (US)

(72) Inventors: Alfredo R. Munoz, Ann Arbor, MI (US); Michael W. Degner, Novi, MI (US); Michael T. Berhan, Sylvania, OH (US); Shaun G. Knowles, Canton, MI (US); Thomas A. McGinn, White Lake, MI (US)

(73) Assignee: FORD GLOBAL TECHNOLOGIES, LLC, Dearborn, MI (US)

(21) Appl. No.: 13/227,506

(22) Filed: Sep. 8, 2011

(51) Int. Cl. B60K 6/54; F16H 3/72; F16H 37/06

(52) U.S. Cl. 475/5; 74/665 A; 180/65.21; 903/902

(57) ABSTRACT

A motor vehicle powertrain includes an engine, a motor/generator including a rotor, gearing including an input driveably connected to the engine, and an output secured to the rotor and driven in a rotary direction opposite to that of the input.

### BACKGROUND OF THE INVENTION

1. Field of the Invention

This invention relates generally to an apparatus for counteracting a rolling moment produced by a power source, such as an engine, particularly in a motor vehicle powertrain.

2. Description of the Prior Art

When a spinning mass supported on a frame is accelerated or decelerated about the axis of spin, a dynamic reaction torque is transferred to the frame. This reaction torque, known as a rolling moment, tends to rotate the whole assembly around the axis of rotation. If the frame is mounted on elastic mountings, the whole frame will experience a small rotation with respect to the steady state position every time acceleration or deceleration of the mass is produced. To accommodate for these movements and prevent the assembly from striking other objects in close proximity, extra space is needed around the assembly. The rolling moment also produces additional mechanical stress in the support on which the mass is mounted.

In a motor vehicle whose available space in the engine compartment under the hood is very limited, the need for additional empty space around any assembly or system is critical. In particular, the engine of a vehicle tends to exhibit a rather large rolling moment during sudden accelerations, resulting in a large voided, wasted space around the engine and transmission as that assembly rolls on the elastic engine supports located on the vehicle's chassis. If a rotating load is attached to the engine output shaft, such that this load would counteract and reduce the rolling moment of the combined engine load system, the rocking movement of the engine load can be reduced, thus reducing the amount of wasted space.

### SUMMARY OF THE INVENTION

A motor vehicle powertrain includes an engine, a motor/generator including a rotor, gearing including an input driveably connected to the engine, and an output secured to the rotor and driven in a rotary direction opposite to that of the input.

By having the genset rotor and engine shaft 14 rotate in opposite directions, the net rolling moment during sudden engine accelerations and decelerations is reduced, thus the relative movement of the powertrain system with respect to the mounting bosses, is reduced.

Use of a gearbox between the generator and the engine helps reduce the total packaging volume/weight and improves overall system efficiency. An appropriate gear ratio can be chosen and the generator can be designed for optimal performance and minimum size while matching the engine speed vs. torque profile.

Because of the smaller relative engine movement, other under-the-hood subsystems can be packaged closer to the engine yielding new space saving opportunities.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

The invention will be more readily understood by reference to the following description, taken with the accompanying drawings, in which:

FIG. 1 is a top view of a powertrain for a hybrid electric vehicle;

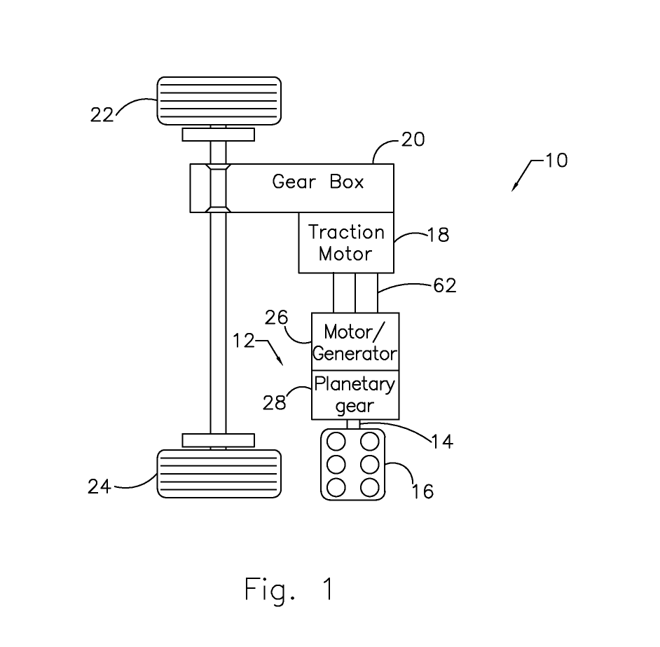

FIG. 2 is cross section taken at a diametric plane through an electric machine and planetary gear unit of the powertrain of FIG. 1; and

FIG. 3 is a schematic diagram of an alternate arrangement of the planetary gearing.

### DESCRIPTION OF THE PREFERRED EMBODIMENT

Referring now to the drawings, powertrain 10, for use in a series hybrid electric vehicle (SHEV), includes an electric generator-gearbox set 12 (also called a genset), driveably connected to the crankshaft 14 of an internal combustion engine 16; a traction motor 18, connected in series with the engine 16 and genset 12; a gearbox 20, driveably connected to the traction motor for producing a range of forward ratios of the speed of the traction motor divided by the speed of the gearbox output and reverse drive; and traction wheels 22, 24 of the vehicle. No direct mechanical connection exists between the engine 16 and the traction wheels 18, 20.

The genset 12 comprises a motor-generator 26 and planetary gearing 28 arranged in series between the engine crankshaft 14 and traction motor 18. The electric motor/generator 26 is mechanically coupled to a counter-rotating planetary gear unit 28.

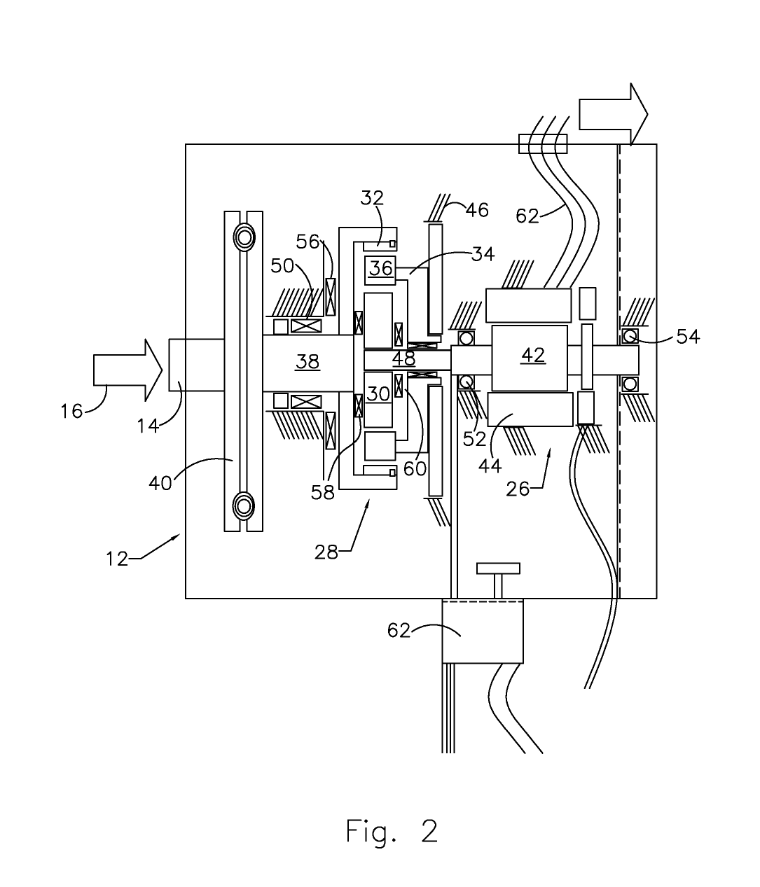

The gear unit 28 includes a sun gear 30, ring gear 32, planet carrier 34, and planet pinions 36 supported on the carrier and meshing with the sun gear 30 and ring gear 32. An input shaft 38 is secured to ring gear 32. A torsion damper 40 connects crankshaft 14 and input shaft 38. As FIG. 2 shows, the rotor 42 of the motor/generator 26 is connected to the sun gear 30, and the stator 44 is grounded to prevent its rotating. The carrier 34 of gear unit 28 is also grounded at 46 to prevent its rotating. Although this is the preferred configuration, it is understood that the carrier 34 could be allowed to rotate as well. If the carrier slips and the resultant moment transmitted to the surrounding structure is reduced, it may be better from an NVH perspective.

Due to torsion reaction of gear unit 28 being provided by carrier 28, sun gear 30, shaft 48 and the rotor 42 of motor/generator 26 are overdriven relative to the speed of crankshaft 14 and input shaft 38. Sun gear 30, shaft 48 and the rotor 42 of motor/generator 26 rotate in the opposite direction from the direction of rotation of crankshaft 14 and input shaft 38.

Input shaft 38 is supported on a bearing 50, fitted in a housing. Rotor 42 is supported on bearings 52, 54, fitted in a housing. Thrust bearings 56, 58, 60 react on the housing thrust forces produced by the use of helical gears in the planetary gearing 28.

A hydraulic pump 62, driven in rotation by the rotor shaft, provides a source of hydraulic line pressure for gearbox 20, planetary gearing 26 and the bearings.

The motor/generator 26 is electrically connected by conductors 64 to the traction motor 18.

The planetary gear unit 28 is compact, efficient and achieves both the counter-rotating effect and maintains the rotor 42 axis and input shaft 38 axis mutually aligned, thereby transmitting an oppositely directed rolling moment to the prime mover 16, which operates to at least partially cancel the rolling moment produced by engine 14.

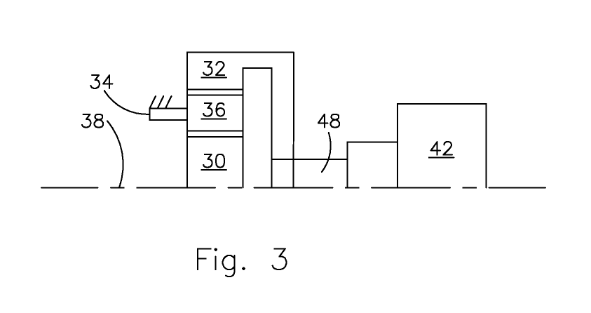

Other planetary gear configurations could also be used as long as the input shaft and generator rotor rotate in opposite directions. For example, as shown in FIG. 3, if sun gear 30 were secured to input shaft 38, ring gear 32 were secured to shaft 48 and rotor 42, and carrier is maintained fixed against rotation, ring gear 32, shaft 48 and the rotor 42 of motor/generator 26 would rotate in the opposite direction from the direction of rotation of crankshaft 14 and slower than the speed of crankshaft 14 and input shaft 38.

Because the motor/generator rotor 42 and engine shaft 14 rotate in opposite directions, the net rolling moment during sudden engine accelerations and decelerations is reduced, thus the relative movement of the powertrain system 10 with respect to the mounting bosses, such as engine mounts, is also reduced. In addition, use of a gearing between the generator and the engine helps reduce the total packaging volume/weight and improves overall system efficiency. By choosing the appropriate gear ratio the generator can be designed for optimal performance and minimum size while matching the engine speed vs. torque profile.

Because of the smaller relative engine movement, other under-the-hood subsystems can be packaged closer to the engine 16 providing new space saving opportunities. From the perspective of the motor/generator 26, the direction of rotation is unimportant. Therefore, no penalty results due to the counter-rotating gearing 28 and motor/generator 26.

Although the description is based on a series generator topology it is understood that this arrangement, and its benefits, could be used in any situation where an engine is attached to a spinning load.

In accordance with the provisions of the patent statutes, the preferred embodiment has been described. However, it should be noted that the alternate embodiments can be practiced otherwise than as specifically illustrated and described.

The invention claimed is:

1. A motor vehicle powertrain, comprising:
an engine;
a motor/generator including a rotor;
gearing including an input driveably connected to the engine, and an output secured to the rotor and driven in a rotary direction opposite to that of the input.

2. The powertrain of claim 1, wherein the output is overdriven relative to the speed of the input.

3. The powertrain of claim 1, wherein the gearing includes:
a sun gear connected to the output;
a ring gear connected to the input;
a planet carrier secured against rotation; and
planet pinions supported on the carrier and meshing with the sun gear and ring gear.

4. The powertrain of claim 1, wherein the output is underdriven relative to the speed of the input.

5. The powertrain of claim 1, wherein the gearing includes:
a sun gear connected to the input;
a ring gear connected to the output;
a planet carrier secured against rotation; and
planet pinions supported on the carrier and meshing with the sun gear and ring gear.

6. The powertrain of claim 1, further comprising:
a traction motor;
driven wheels of the vehicle; and
a gearbox including a second output connected to the driven wheels, the gearbox producing a range of forward ratios of a speed of the traction motor divided by a speed of the second output and reverse drive.

7. A motor vehicle powertrain, comprising:
an engine including;
a motor/generator including a rotor;
planetary gearing including an input driveably connected to the power source, and an output secured to the rotor and driven at a speed different from a speed of the engine and in a rotary direction opposite to that of the input.

8. The powertrain of claim 7, wherein the output is overdriven relative to the speed of the input.

9. The powertrain of claim 7, wherein the planetary gearing includes:
a sun gear connected to the output;
a ring gear connected to the input;
a planet carrier secured against rotation; and
planet pinions supported on the carrier and meshing with the sun gear and ring gear.

10. The powertrain of claim 7, wherein the planetary gearing includes:
a sun gear connected to the output;
a ring gear connected to the input;
a planet carrier that rotates; and
planet pinions supported on the carrier and meshing with the sun gear and ring gear.

11. The powertrain of claim 7, wherein the output is underdriven relative to the speed of the input.

12. The powertrain of claim 7, wherein the gearing includes:
a sun gear connected to the input;
a ring gear connected to the output;
a planet carrier secured against rotation; and
planet pinions supported on the carrier and meshing with the sun gear and ring gear.

13. The powertrain of claim 7, wherein the gearing includes:
a sun gear connected to the input;
a ring gear connected to the output;
a planet carrier that rotates; and
planet pinions supported on the carrier and meshing with the sun gear and ring gear.

14. The powertrain of claim 7, further comprising:
a traction motor;
driven wheels of the vehicle; and
a gearbox including a second output connected to the driven wheels, the gearbox producing a range of forward ratios of a speed of the traction motor divided by a speed of the second output and reverse drive.

15. A method for resisting a rolling moment produced by rotary acceleration and deceleration, comprising:
(a) connecting an engine to an input of a planetary gearset;
(b) connecting an output of said gearset to a rotor of a motor/generator;
(c) holding against rotation a component of the gearset such that the output and rotor rotate in a direction opposite to the rotary direction of the engine.

16. The method of claim 13, further comprising holding against rotation a component of the gearset such that the output and rotor rotate at a greater speed than a speed of the engine.
